(19) United States
(12) Patent Application Publication
(10) Pub. No.: US 2012/0286911 A1
(43) Pub. Date: Nov. 15, 2012

(54) Variable effort magnetic brake assist for physically handicapped persons

(75) Inventors: Jeff Walker, Centreville, MD (US); Zane Walker, Centreville, MD (US)

(73) Assignee: Innovative Mobility Solutions, LLC, Centreville, MD (US)

(21) Appl. No.: 13/068,359

(22) Filed: May 10, 2011

(51) Int. Cl. H01F 7/02

(52) U.S. Cl. 335/302

(57) ABSTRACT

A magnetic reduced effort braking apparatus for use to reduce the amount of effort required to depress the brake pedal of a vehicle. A rigid plate is secured to the floor of a vehicle between the gas pedal and the brake pedal and adjacent to the brake pedal and a first magnet is secured to the rigid plate. A second magnet is secured to the underside of the brake pedal slightly aligned with but slightly offset from the location of the first magnet. The magnets attract one another and reduce the amount of foot pressure required to depress the brake pedal.

### CROSS-REFERENCE TO RELATED APPLICATIONS

The present application does not derive priority from any prior applications.

### BACKGROUND OF THE INVENTION

1. Field of the Invention

The present invention relates generally to mechanisms for improving the ability for handicapped individuals to control the braking system of an automobile or other motorized vehicle. More particularly, this invention relates to an improved reduced effort braking apparatus that utilizes magnetic forces to permit an individual with reduced strength and/or functioning of his/her hands, wrists, and/or arms as well as legs, feet or ankles to more easily and safely control the braking of an automobile or other motorized vehicle.

2. Description of the Background

The use of devices to provide reduced effort braking for a vehicle is known in the prior art. The prior art includes modifications for both reduced effort and no effort braking systems. These prior devices achieve this function through brake booster modifications which modify the vacuum booster system which comes standard on most motorized gas vehicles. The existing systems permanently modify the existing braking systems and require the addition of a back-up braking system. These existing systems are expensive and are not able to be removed from a vehicle and transferred to another vehicle. While these existing devices may fulfill the objective and purpose of providing reduced effort braking, they do not embody the functional and design features and advantages of this new magnetic reduced effort braking system.

### SUMMARY OF THE INVENTION

A first object of the present invention is to provide an improved reduced effort braking system and apparatus for permitting an individual to apply a lesser amount of pressure to the brake pedal in order to slow and/or stop a moving vehicle. This is desirable to aid handicapped individuals and other individuals with reduced strength and/or functioning in their hands, wrists, and/or arms as well as legs, feet or ankles to more safely operate a motor vehicle. This is also beneficial for handicapped individuals who have lost the use of their legs and operate a vehicle through the use of hand controls. The present invention makes it possible for such an individual to more easily and safely control the brakes of the vehicle even if the individual has reduced strength and/or functioning of his/her hands, wrists, and/or arms.

Automobiles have braking systems factory installed in them. These factory installed braking systems typically require the operator of the vehicle to apply approximately 20 foot pounds of pressure to the brake pedal to slow/stop the vehicle.

A second object of the present invention is to provide a reduced effort braking system and apparatus that is capable of being used on any vehicle. While existing reduced effort braking systems are only available for gasoline powered vehicles, the present invention can be used on any vehicle including, gas vehicles, diesel vehicles, hybrid vehicles, and electric vehicles.

A third object of the present invention is to provide a reduced effort braking system and apparatus that is affordable and capable of being transferred from one vehicle to another with minimal effort. The reduced effort braking apparatus of the present invention does not permanently alter the vehicles braking system and is easily removable to allow the braking system of the vehicle to be returned to its original setup. Additionally, because the present invention is easily removed, when the owner purchases a new vehicle he/she does not need to purchase a new reduced effort braking system, which can be very expensive, he/she can simply remove the apparatus and install the same apparatus on the new vehicle with minimal effort. Since the present invention does not modify the vehicle's OEM system it will continue to reduce the effort required to apply the brakes of the vehicle in the event that the engine loses power without the requirement of an additional back-up braking system. The operator of the vehicle can still brake the vehicle with reduced effort even in the event of the vehicle's loss of power.

According to the present invention, the reduced effort braking apparatus is comprised of a series of magnets and plates. A first magnet with a substantially smooth lower surface is secured to a rigid plate with a bolt, screw or other suitable means for securing the first magnet to the rigid plate. In some embodiments there may be a plurality of bolts, screws or other suitable means utilized to secure the first magnet to the rigid plate. The rigid plate is then secured to the floor of a vehicle, either to the left or to the right of the brake pedal, with a plurality of bolts, screws or other suitable means for securing the plate to the floor of a vehicle. Suitable means for securing the plate to the floor of a vehicle could potentially include, among other means, industrial strength Velcro or industrial strength double-sided tape. A second magnet with a plurality of openings, at least one, passing through the magnet is secured to the underside of the brake pedal with bolts, screws or other suitable means for securing the second magnet to the brake pedal. The second magnet is secured to either the left or right side of the underside of the brake pedal to coincide with the side of the brake pedal where the first magnet is secured to the floor of the vehicle. The precise locations where the first and second magnets are secured are such that they are not directly in-line with one another but are slightly shifted so that when the brake pedal is fully depressed there is no possibility that the magnets will come into direct contact with one another. While the alignment of the magnets is not direct it is sufficiently close to retain the attraction between the magnets and it is this attraction between the magnets that reduces the effort required in the application of the brakes and the slowing/stopping of the vehicle. An advantage of this system is that the amount of reduced effort provided by the present invention can be adjusted simply by adjusting the location of the magnets permitting each individual user to achieve the amount of reduced effort braking that is appropriate for their particular needs.

In some embodiments, the first magnet may be comprised of a solid block rectangular shape, while in other embodiments the magnet may be comprised of a stepped type shape. In a typical embodiment the second magnet that is secured to the underside of the brake pedal will be comprised of a solid block rectangular shape, while in other embodiments the shape may be a round or oval block.

The magnets utilized in the present invention are of a sufficient strength to attract one another so as to provide the reduced effort braking of an automobile. Examples of the types of magnets intended for use in the present invention are permanent magnets. Other types of magnets may also be utilized without compromising the integrity or functionality of the present invention so long as the strength of both magnets is sufficient to achieve the desired results.

### BRIEF DESCRIPTION OF THE DRAWINGS

FIG. 1 is an overall overhead view of the brake pedal and gas pedal of an automobile with a first magnet mounted to the floor of the vehicle between the brake pedal and the gas pedal and a second magnet mounted to the underside of the right hand end of the brake pedal.

FIG. 2 is an overall overhead view of the brake pedal and gas pedal of an automobile with a first magnet mounted to the floor of the vehicle to the left of the brake pedal and a second magnet mounted to the underside of the left hand end of the brake pedal.

FIG. 3 is an overall straight ahead view of the brake pedal and gas pedal of an automobile with a first magnet mounted to the floor of the vehicle between the brake pedal and the gas pedal and a second magnet mounted to the underside of the right hand end of the brake pedal.

FIG. 4 is an overall straight ahead view of the brake pedal and gas pedal of an automobile with a first magnet mounted to the floor of the vehicle to the left hand side of the bake pedal and a second magnet mounted to the underside of the left hand end of the brake pedal.

FIG. 5 is an angled side view of the first magnet.

FIG. 6 is an angled side view of the second magnet.

FIG. 7 is an angled side view of the first and second magnet aligned with one another and illustrating the polarity of each side of each magnet.

FIG. 8 is an angled side view of the rigid plate that is utilized to secure the first magnet to the floor of the vehicle.

FIG. 9 is an angled side view of a first magnet with a solid rectangular block formation separated from and above a rigid plate.

FIG. 10 is an angled overhead view of a first magnet with a solid rectangular block formation attached to a rigid plate.

FIG. 11 is a side view through the driver's side door of a vehicle illustrating the brake pedal, a first magnet with a solid rectangular block formation mounted to the floor of the vehicle and a second magnet mounted to the underside of the brake pedal.

FIG. 12 is a side view through the driver's side door of a vehicle illustrating the brake pedal, a first magnet with a solid stepped formation mounted to the floor of the vehicle and a second magnet mounted to the underside of the brake pedal.

### DETAILED DESCRIPTION OF THE PREFERRED EMBODIMENTS

The present invention relates to an apparatus for improving the ability for handicapped individuals to control the braking system of an automobile or other motorized vehicle. Specifically, this invention relates to an improved reduced effort braking apparatus that utilizes magnetic forces to permit an individual with reduced strength and/or functioning of his/her hands, wrists, and/or arms as well as legs, feet or ankles to more easily and safely control the steering of an automobile.

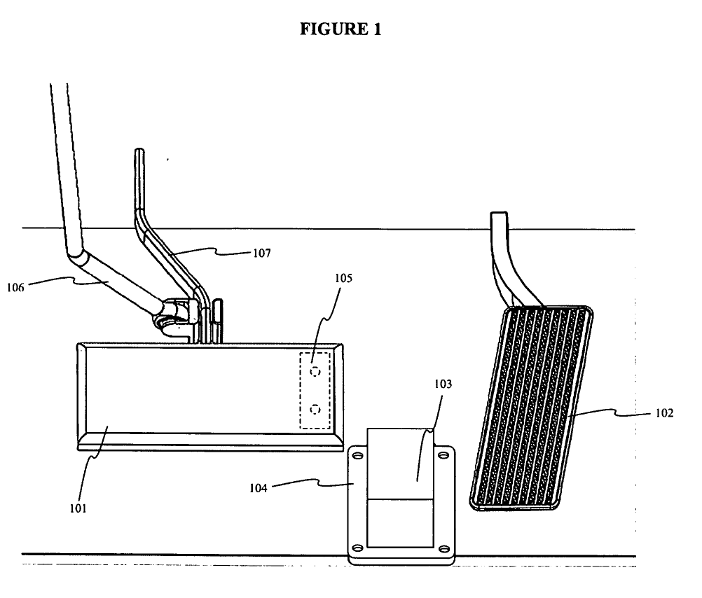

FIG. 1 illustrates an overall overhead view of the brake pedal 101 and gas pedal 102 of an automobile with a first magnet 103 mounted to a rigid plate 104 which is mounted to the floor of the vehicle and a second magnet 105 (seen here outlined with the dashed line illustrating the position of the second magnet 105 on the underside of the brake pedal 101) mounted to the underside of the brake pedal 101. As illustrated, the first magnet 103 is mounted in a position between the gas pedal 102 and the brake pedal 101, and the second magnet 105 is mounted on the underside of the right-hand end of the brake pedal 101, such that when the brake pedal 101 is fully depressed the second magnet 105 does not meet the first magnet 103. With this positioning the magnetic force of the first magnet 103 attracts the magnetic force of the second magnet 105. This attraction between the first magnet 103 and the second magnet 105 serves to substantially decrease the amount of foot pressure required to depress the brake pedal 101. The positioning of the first magnet 103 is also such that it does not interfere with depressing the gas pedal 102. Also illustrated in this figure are the lever 107 of the brake pedal 101 which connects the brake pedal 101 to the vehicles factory installed braking system and the arm 106 of a hand controlled braking system which allows the operator of the vehicle to depress the brake pedal 101 through the use of hand controls. The reduced effort braking system of the present invention is able to be used with or without the assistance of hand controls.

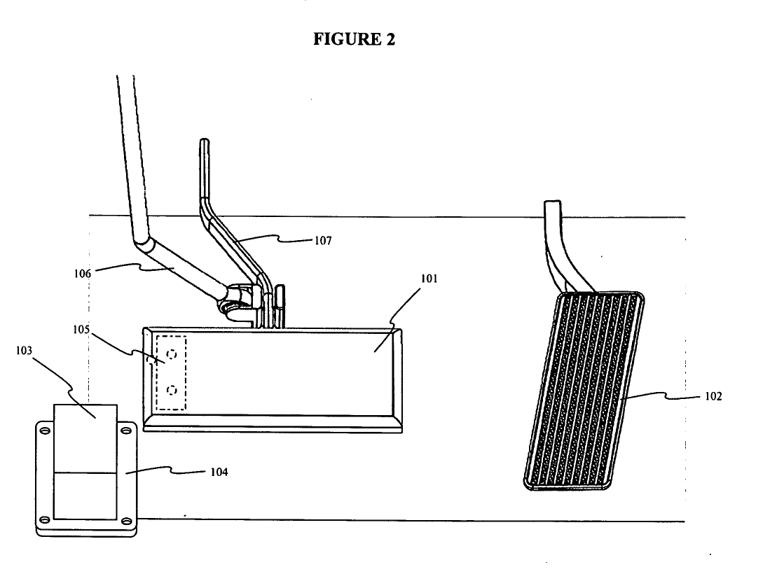

FIG. 2 illustrates an overall overhead view of the brake pedal 101 and gas pedal 102 of an automobile with a first magnet 103 mounted to a rigid plate 104 which is mounted to the floor of the vehicle and a second magnet 105 (seen here outlined with the dashed line illustrating the position of the second magnet 105 on the underside of the brake pedal 101) mounted to the underside of the brake pedal 101. As illustrated, the first magnet 103 is mounted in a position to the left-hand end of the brake pedal 101, and the second magnet 105 is mounted on the underside of the left-hand end of the brake pedal 101, such that when the brake pedal 101 is fully depressed the second magnet 105 does not meet the first magnet 103. With this positioning the magnetic force of the first magnet 103 attracts the magnetic force of the second magnet 105. This attraction between the first magnet 103 and the second magnet 105 serves to substantially decrease the amount of foot pressure required to depress the brake pedal 101. The positioning of the first magnet 103 is also such that it does not interfere with depressing the gas pedal 102. Also illustrated in this figure are the lever 107 of the brake pedal 101 which connects the brake pedal 101 to the vehicles factory installed braking system and the arm 106 of a hand controlled braking system which allows the operator of the vehicle to depress the brake pedal 101 through the use of hand controls. The reduced effort braking system of the present invention is able to be used with or without the assistance of hand controls.

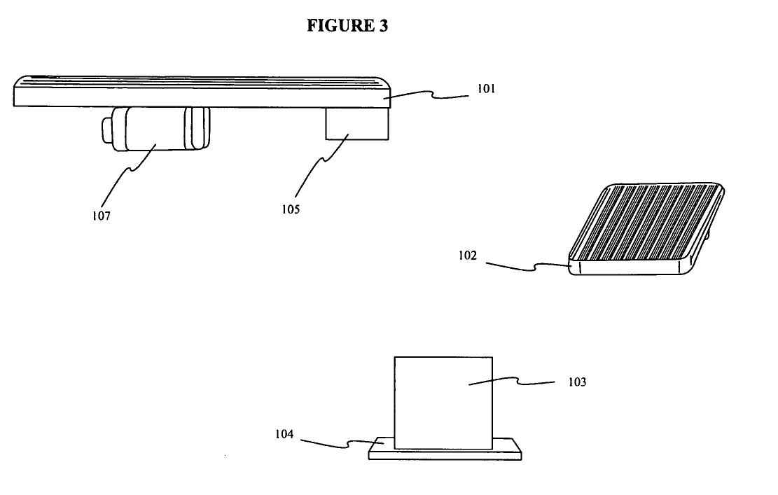

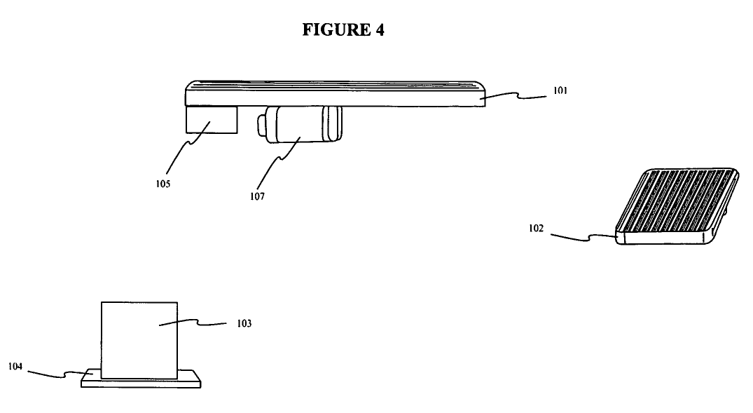

FIG. 3 is a front-end view of the brake pedal 101 and gas pedal 102 of an automobile with a first magnet 103 mounted to a rigid plate 104 which is mounted to the floor of the vehicle and a second magnet 105 mounted to the underside of the brake pedal 101. FIG. 4 illustrates the alignment of the first magnet 103 with the second magnet 105 as well as with the brake pedal 101 and the gas pedal 102. The rigid plate 104 is mounted to the floor of the vehicle between the gas pedal 102 and the brake pedal 101 and the second magnet 105 is secured to the underside of the right-hand end of the brake pedal 101. As shown, it is clear that the first and second magnets (103 and 105) are not directly aligned with one another such that even if the brake pedal 101 were pressed all the way to the floor of the vehicle the first magnet 103 and the second magnet 105 would not meet. This figure also illustrates that the positioning of the first magnet 103 between the brake pedal 101 and the gas pedal 102 does not interfere with the use of the gas pedal 102.

FIG. 4 is the same front-end view as FIG. 3 of the brake pedal 101 and gas pedal 102 of an automobile with a first magnet 103 mounted to a rigid plate 104 which is mounted to the floor of the vehicle and a second magnet 105 mounted to the underside of the brake pedal 101. In this figure the rigid plate 104 is mounted to the floor of the vehicle at the left-hand end of the brake pedal 101 and the second magnet 105 is secured to the underside of the left-hand end of the brake pedal 101. Again in this configuration, it is clear that the first and second magnets (103 and 105) are not directly aligned with one another such that even if the brake pedal 101 were pressed all the way to the floor of the vehicle the first magnet 103 and the second magnet 105 would not meet.

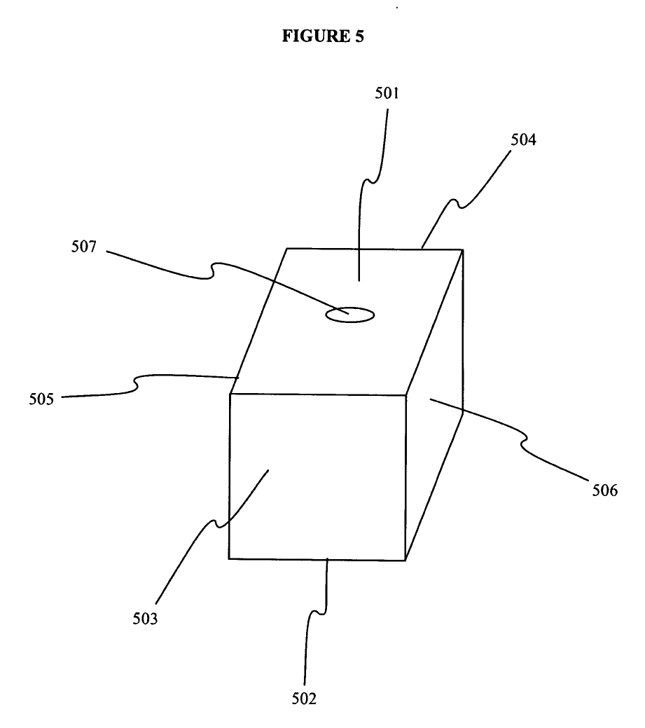

FIG. 5 is an angled side view of the first magnet 103 and illustrates that the first magnet 103 is a six-sided rectangular cube. The first magnet 103 has a top-side 501, a bottom-side 502, a front-side 503, a back-side 504, a left-side 505, and a right-side 506. Also illustrated in this figure is a channel 507 that passes through the first magnet 103 from the top-side 501 through to the bottom-side 502. A means for securing the first magnet 103 to the right plate 104 is passed through the channel 507 to secure the first magnet 103 to the rigid plate 104. In some embodiments the first magnet 103 may possess a plurality of channels 507 for use in securing the first magnet 103 to the rigid plate 104.

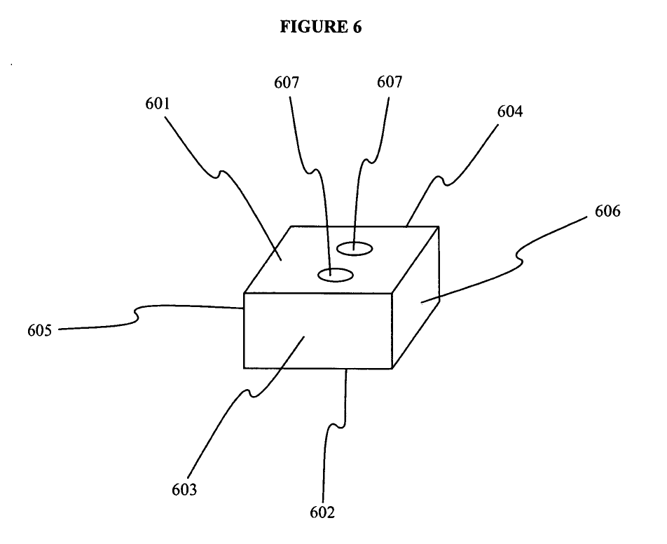

FIG. 6 is an angled side view of the second magnet 105 and illustrates that the second magnet 105 is also a six-sided rectangular cube. The second magnet 105 has a top-side 601, a bottom-side 602, a front-side 603, a back-side 604, a left-side 605, and a right-side 606. Also illustrated in this figure is a pair of channels 607 that pass through the second magnet 105 from the bottom-side 602 through to the top-side 601. A plurality of means for securing the second magnet 103 to the underside of the brake pedal 101 are passed through the channels 607 to secure the second magnet 105 to the underside of the brake pedal 101.

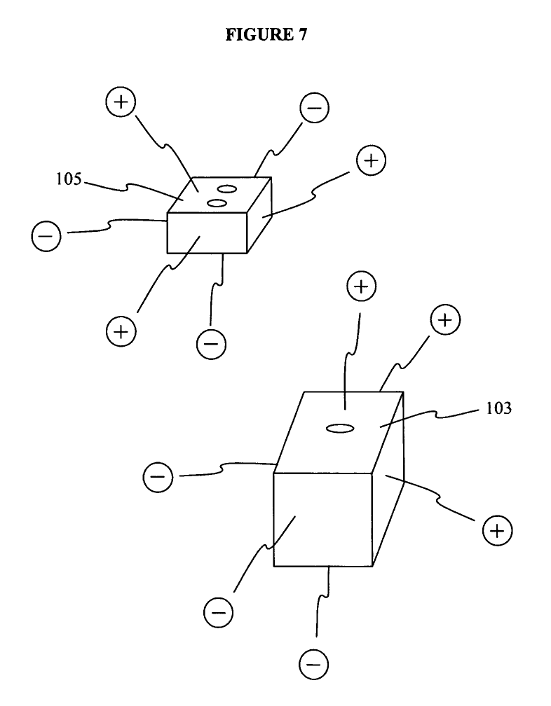

FIG. 7 is an angled side view of the first magnet 103 and the second magnet 105 aligned with one another and illustrating the polarity of each side of each magnet. The polarity of both the first magnet 103 and the second magnet 105 are depicted and illustrate that the aligned in opposite so that throughout the traveling of the brake pedal 101 as it is depressed there is an attraction between the two magnets that is always maintained. The charges associated with each of the sides of the first magnet 103 are illustrated and show that the top-side 501 has a positive charge, the bottom-side 502 has a negative charge, the front-side 503 has a negative charge, the back-side 504 has a positive charge, the left-side 505 has a negative charge, and the right-side 506 has a positive charge. The charges associated with each of the sides of the second magnet 105 are illustrated and show that the top-side 601 has a positive charge, the bottom-side 602 has a negative charge, the front-side 603 has a positive charge, the back-side 604 has a negative charge, the left-side 605 has a negative charge, and the right-side 606 has a positive charge. The alignment of the first magnet 103 with the second magnet 105 is critical to obtaining the correct functioning of the magnetic brake assist and the maintenance of constant attraction between the magnets.

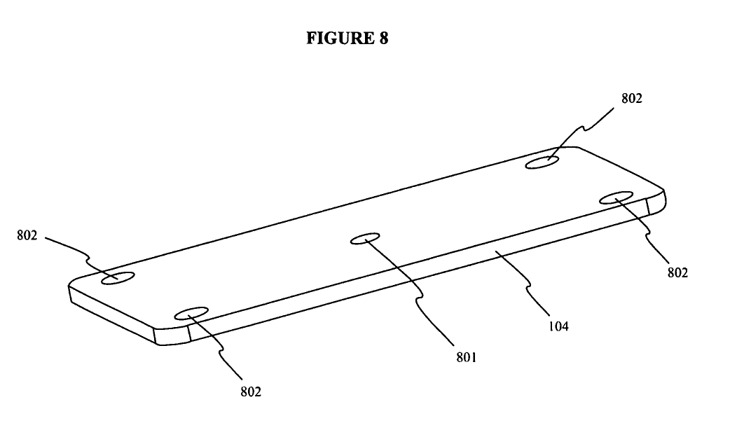

FIG. 8 is an angled side view of the rigid plate 104 that is utilized to secure the first magnet 103 to the floor of the vehicle. As illustrated, the rigid plate 104 is substantially flat with rounded corners (the rounded corners are not necessary and in some embodiments the rigid plate 104 may not have rounded corners). Also as illustrated, the rigid plate 104 has a single substantially round opening 801 through the center of the rigid plate 104 that is used in securing the first magnet 103 to the rigid plate 104. In some embodiments there may be a plurality of openings through the rigid plate 104 along the midline of the rigid plate 104 for use in securing the first magnet 103 to the rigid plate 104. The rigid plate 104 also possesses a plurality of openings 802 through the rigid plate 104 placed along the perimeter of the rigid plate 104 for use in securing the rigid plate 104 to the floor of the vehicle. In some embodiments the openings 801 and 802 through the rigid plate 104 may have smooth sides while in other embodiments they may be threaded for use with a particular means for securing the first magnet 103 to the rigid plate 104 or for securing the rigid plate 104 to the floor of the vehicle.

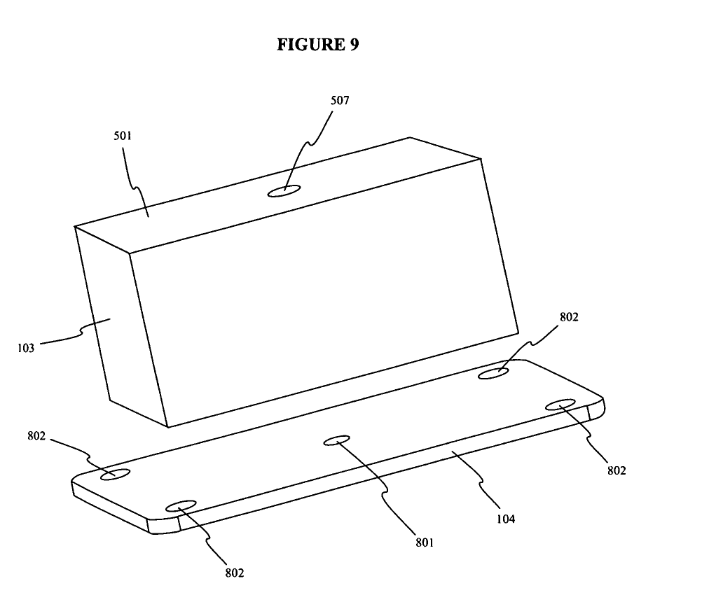

FIG. 9 is an angled side view of a first magnet 103 with a solid rectangular block formation separated from and above a rigid plate 104. Also visible in this figure is the top of the channel 507 which passes through the first magnet 103 from the upper surface 501 to the lower surface 502. A means for securing the first magnet 103 to the rigid plate 104 is passed through the channel 507 to secure the first magnet 103 to the rigid plate 104 by inserting the means for securing into or through the opening 801 of the rigid plate 104. Also illustrated are a plurality of openings 802 through the rigid plate 104 through which a plurality of means for securing the rigid plate 104 to the floor of the vehicle are passed through the rigid plate 104 to secure the rigid plate 104 to the floor of the vehicle.

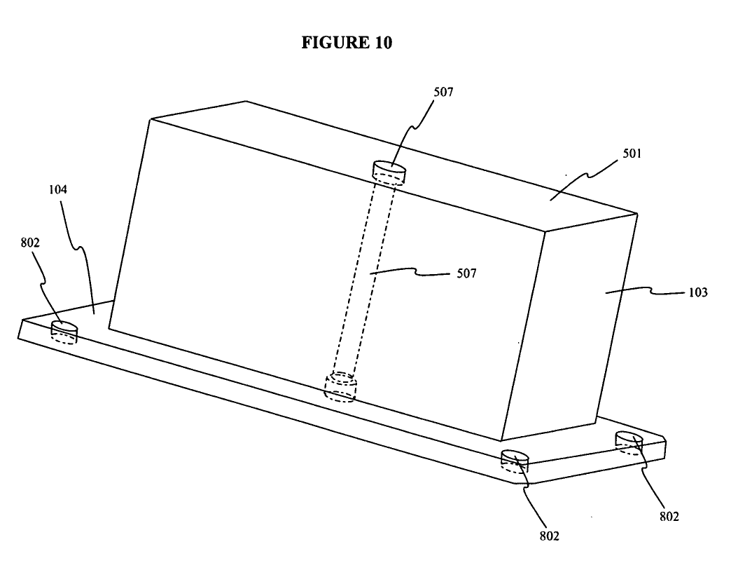

FIG. 10 is an angled overhead view of a first magnet 103 with a solid rectangular block formation attached to a rigid plate 104. Also visible in this figure is the channel 507 which passes through the first magnet 103 from the upper surface 501 to the lower surface 502. A means for securing the first magnet 103 to the rigid plate 104 is passed through the channel 507 of the first magnet 103 and through the opening 801 of the rigid plate 104 to secure the first magnet 103 to the rigid plate 104. Also clearly illustrated are a plurality of openings 802 through the rigid plate 104 through which a plurality of means for securing the rigid plate 104 to the floor of the vehicle are passed through the rigid plate 104 to secure the rigid plate 104 to the floor of the vehicle.

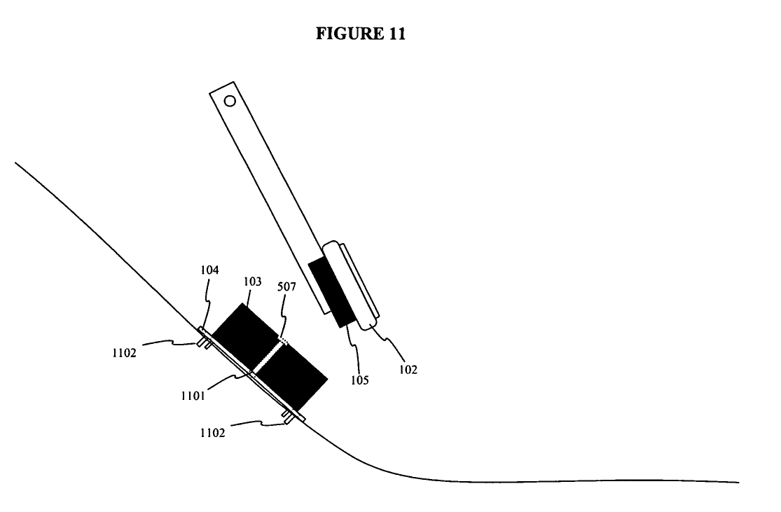

FIG. 11 illustrates a side view looking in through the driver's side door of a vehicle illustrating the brake pedal 101, a first magnet 103 mounted to a rigid plate 104 that is then mounted the floor of the vehicle and a second magnet 105 mounted to the underside of the brake pedal 101. As shown the brake pedal 101 is in the non-depressed position. This figure also illustrates a channel 507 through the center of the first magnet 103 through which a screw, bolt or other suitable means for securing 1101 the first magnet 103 to the rigid plate 104 is passed to attach the first magnet 103 to the rigid plate 104. Once the first magnet 103 is secured to the rigid plate 104 the rigid plate 104 is then secured to the floor of the vehicle with a plurality of screws, bolts, or other suitable means for securing 1102 the plate to the floor of the vehicle.

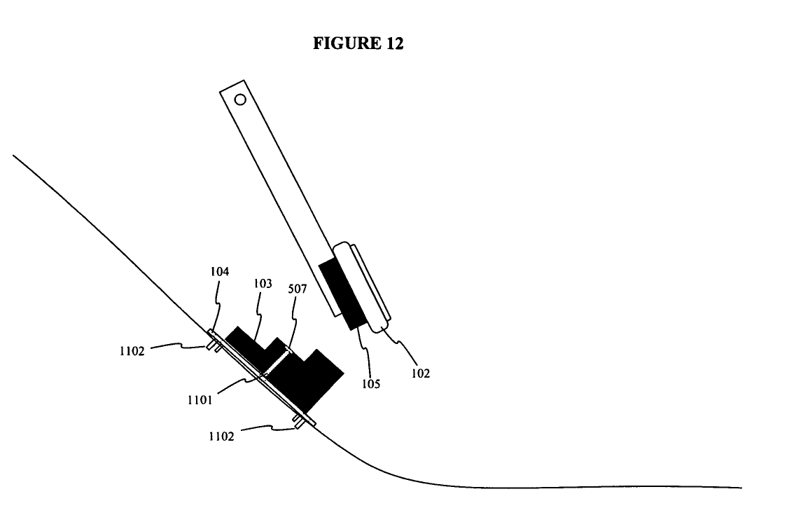

FIG. 12 illustrates the same view as FIG. 11 and illustrates the first magnet 103 with a stepped formation attached to a rigid plate 104. This stepped formation results in a slightly weaker draw between the first magnet 103 and the second magnet 105 and thus results in a lesser amount of reduction in the effort required to apply the brake pedal 101.

A number of embodiments have been described. Nevertheless, it will be understood that various modifications may be made without departing from the spirit of the scope of the invention. For example, the physical shapes, dimensions and materials of the various system components (e.g. the first magnet, the second magnet, and the means for securing the magnets to the floor of the vehicle or to the underside of the brake pedal, etc.) can vary considerably. For example, in some implementations, the means for securing a first magnet to the rigid plate may be a screw, while in other embodiments it may be a bolt or some other suitable means for securing a first magnet to the rigid plate. As another example, in some implementations the first magnet may be a solid rectangular block, while in other implementations the first magnet may have a stepped formation with a plurality of upper surfaces.

Other implementations are within the scope of the claims.

What is claimed is:

1. An apparatus for magnetically reducing the amount of effort required to depress the brake pedal of a vehicle comprising:
a first magnet secured to a rigid plate with a means for securing said first magnet to said rigid plate;
said rigid plate secured to the floor of a vehicle with a plurality of means for securing said rigid plate to the floor of the vehicle;
a second magnet secured to the underside of the vehicle brake pedal with a plurality of means for securing said second magnet to the underside of the vehicle brake pedal and aligned slightly to the left or right of the location of the first magnet mounted to the floor of the vehicle, wherein the polarity of the first and second magnets are aligned such that the first and second magnets are each attracted to the other.

2. The apparatus of claim 1, wherein the first magnet is in the shape of a solid rectangular block.

3. The apparatus of claim 1, wherein the first magnet has a tiered shape with three differing thicknesses from top to bottom.

4. The apparatus of claim 1, wherein the plurality of means for securing said rigid plate to the floor of the vehicle are self tapping screws.

5. The apparatus of claim 1, wherein the plurality of means for securing said rigid plate to the floor of the vehicle are nut and bolt assemblies.

6. The apparatus of claim 1, wherein the means for securing said first magnet to said rigid plate is a nut and bolt assembly.

7. The apparatus of claim 1, wherein the means for securing said first magnet to said rigid plate is a rigid clamp.

8. The apparatus of claim 1, wherein the plurality of means for securing said second magnet to the underside of the vehicle brake pedal are self tapping screws.

9. The apparatus of claim 1, wherein the plurality of means for securing said second magnet to the underside of the vehicle brake pedal are nut and bolt assemblies.

10. The apparatus of claim 1, wherein said rigid plate with the first magnet secured to it is secured to the floor of a vehicle to the right-hand side of the vehicle brake pedal and the second magnet is secured to the underside of the right-hand end of the brake pedal.

11. The apparatus of claim 1, wherein said rigid plate with the first magnet secured to it is secured to the floor of a vehicle to the left-hand side of the vehicle brake pedal and the second magnet is secured to the underside of the left-hand end of the brake pedal.
